(19) United States
(12) Patent Application Publication
(10) Pub. No.: US 2015/0205724 A1
(43) Pub. Date: Jul. 23, 2015

(54) SYSTEM AND METHOD OF CACHE PARTITIONING FOR PROCESSORS WITH LIMITED CACHED MEMORY POOLS

(71) Applicant: Honeywell International Inc., Morristown, NJ (US)

(72) Inventors: William Ray Hancock, Phoenix, AZ (US); Larry James Miller, Black Canyon City, AZ (US)

(73) Assignee: Honeywell International Inc., Morristown, NJ (US)

(21) Appl. No.: 14/159,180

(22) Filed: Jan. 20, 2014

(51) Int. Cl. G06F 12/08

(52) U.S. Cl. CPC G06F 12/0848; G06F 2212/282

(57) ABSTRACT

A method comprises dividing a main memory into a plurality of pools, the plurality of pools including a first pool and one or more second pools, wherein the first pool is only associated with a set of one or more lines in a first cache such that data in the first pool is only cached in the first cache and wherein the one or more second pools are each associated with one or more lines in a second cache and data in the second cache is cacheable by the first cache. The method further comprises assigning each of a plurality of threads to one of the plurality of pools and determining if a memory region being accessed belongs to the first pool. If the memory region being accessed belongs to the first pool, bypassing the second cache to temporarily store data from the memory region in the first cache.

### BACKGROUND

In real time systems, adequate processing throughput should be available to complete all required tasks. Modern Central Processing Units (CPUs) use various mechanisms to achieve high throughput on average, but may sacrifice guaranteed throughput in the process. For example, one means of achieving higher throughput is via processor instruction or data caches which are high speed memories placed between the CPU and the main memory. In modern CPUs, the cache cannot be allocated to specific tasks running on the CPU and, as a consequence, any task may impact the throughput available to all other tasks by changing the content of the cache. This can affect the guaranteed throughput available to those other tasks.

Furthermore, the effect can be difficult to analyze. Most Integrated Modular Avionics (IMA) systems used for safety critical applications employ a time partitioning scheme to prevent low design assurance tasks from interfering with high design assurance tasks. The presence of non partitioned CPU caches may cause this time partitioning to be partially compromised. One workaround is to provide additional CPU time to each task to account for the non-partitioned nature of the cache, but such a workaround reduces the overall efficiency of the system which can present a problem, for example, in preemptive multi-rate systems, among others.

### SUMMARY

In one embodiment, a method for enabling a computing system is provided. The method comprises dividing a main memory into a plurality of pools, the plurality of pools including a first pool and one or more second pools, wherein the first pool is only associated with a set of one or more lines in a first cache such that data in the first pool is only cached in the first cache (Level 1) and wherein the one or more second pools are each associated with one or more lines in a second cache (Level 2 or higher) and data in the second cache is cacheable by the first cache. The method further comprises assigning each of a plurality of threads to one of the plurality of pools and determining if a memory region being accessed belongs to the first pool. If the memory region being accessed belongs to the first pool, bypassing the second cache to temporarily store data from the memory region in the first cache.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram of one embodiment of an exemplary computing system which implements memory pools only associated with a single respective cache.

FIG. 2 is a diagram of one embodiment of an exemplary caching system.

FIG. 3 is a diagram of one embodiment of another exemplary caching system.

FIG. 4 is a flow chart of one embodiment of a method of enabling a computing system.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

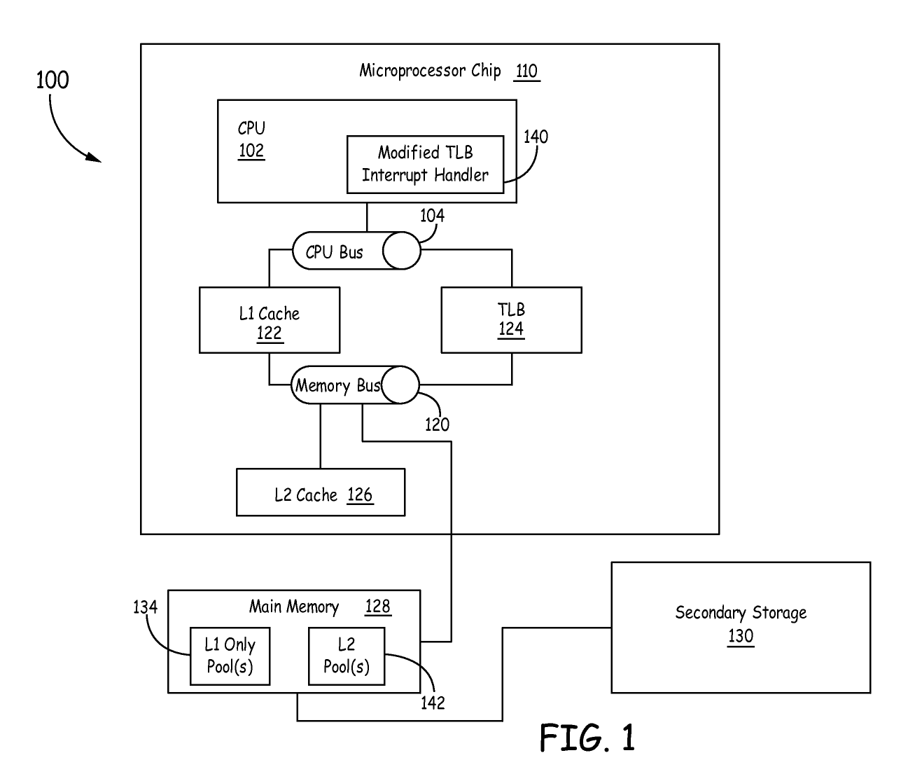

FIG. 1 is a high level block diagram of an exemplary system 100 which implements memory pools only associated with a single respective cache. The microprocessor chip 110 in system 100 comprises a CPU 102 coupled via a CPU bus 104 to at least a level 1 (L1) cache 106 and a translation look-aside buffer 124 (TLB). The L1 cache 122 and TLB 124 contain memory and computing logic. A memory bus 120 couples the L1 cache 122 and TLB 124 to a level 2 (L2) cache 126. Similar to L1 cache 122 and TLB 124, L2 cache 126 contains memory and computing logic. In addition, L2 cache 126 and L1 cache 122 are coupled to main memory 128. Main memory 128 is in turn coupled to secondary storage 130. Without loss of generality, and for the sake of illustration and enablement, it can be assumed that an L2 cache 126 is a smaller, faster memory than main memory 128, and that a secondary storage 130 is a larger, slower memory than main memory 128.

It should be understood, however, that this and other arrangements and processes described herein are set forth for purposes of example only, and other arrangements and elements (e.g., machines, interfaces, functions, orders of elements, etc.) can be added or used instead and some elements may be omitted altogether. Further, as in most computer architectures, those skilled in the art will appreciate that many of the elements described herein are functional entities that may be implemented as discrete components or in conjunction with other components, in any suitable combination and location. For example, in some embodiments, more than one CPU core is included in the microprocessor chip and the CPU bus 118 may consist of multiple independent busses so that each CPU can access its L1 cache 122 and TLB 124 without contending for a CPU bus with the other CPUs. Yet further, L2 cache 126 may be either within the microprocessor chip 110 or part of another chip in the system. Even further, a system may contain multiple independent main memories and secondary storages, not shown in FIG. 1. Each unit of memory in system 100 may comprise semiconductor memory, magnetic memory, optical memory, acoustic memory, biological memory, or any combination of these memory technologies, or any other memory technology used in conjunction with computational devices. In other embodiments, the CPU 102 may also have additional levels of caching, particularly for multi-core systems, such as level 3 (L3) cache that can also be partitioned comparably to L2 cache 126.

The purpose of the L1 cache 122 and the L2 cache 126 in system 100 is to temporarily hold instructions, data, or both, that are being used by tasks executing on CPU 102. As is known to those skilled in the art, patterns of computer memory access exhibit both spatial and temporal locality of reference. That is, once a location, Mx, in main memory 128 is accessed, it is likely that a nearby location, My, in main memory 128 will also be accessed, and it is also likely that location Mx will be accessed again soon. Thus, it is advantageous to store data from recently-accessed main memory 128 locations and their neighboring locations in a fast-memory cache, such as L2 cache 126, because it is likely that CPU 102 will once again have to access one of those main memory 128 locations. By storing the data from locations in main memory 128 within L2 cache 126 and L1 cache 122, the system avoids the latency of having to access main memory 128 or secondary storage 130 to read the data.

While the basic unit of storage in many programming languages is the byte (8 bits), typical CPUs use a unit of operation that is several bytes. For example, in a 32-bit microprocessor, memory addresses are typically 32 bits wide. Thus, for main memories that are byte-addressable, a 32-bit microprocessor can address 2³² (4,294,967,296) individual bytes (4 Gigabytes), where those bytes are numbered 0 through 4,294,967,295. Due to spatial locality of reference, microprocessors typically cache main memory 128 in groups of bytes called “lines.” Each line is a fixed number of contiguous bytes. For example, a 32-bit microprocessor might have a line size of 16 bytes, which means that when a byte from main memory 128 is fetched into L2 cache 126, the rest of the line is brought into L2 cache 126 as well. Thus, when referring to locations in both main memory 128 and L2 cache 126 or L1 cache 122, depending on context, the granularity may be any of various sizes between bytes and lines.

Regardless of the mechanics of memory access, the fact that L2 cache 126 and L1 cache 122 are typically much smaller than main memory 128 means that not all main memory 128 locations can be simultaneously resident in L2 cache 126 or L1 cache 122. In order to maintain performance, L2 cache 126 typically will utilize an algorithm which maps each main memory 128 location to a limited number of L2 cache 126 locations. As stated above, in modern CPUs the cache cannot be allocated to specific tasks running on the CPU and as a consequence any task may impact the throughput available to all other tasks by changing the content of the cache. One effective solution to this problem involves L2 cache partitioning as described in U.S. Pat. No. 8,069,308, which is incorporated herein by reference. Thus, by selectively choosing the addresses of main memory that real time tasks occupy, for example, it is possible to also restrict which areas of the L2 cache the real time tasks can occupy.

However, a limitation exists on some microprocessors in trying to implement the L2 cache partitioning described in the U.S. Pat. No. 8,069,308 (referred to herein as the '308 patent). For example, with respect to some Microprocessor without Interlocked Pipeline Stages (MIPS) processors, there are a limited number of distinct memory pools. The number of distinct memory pools is a factor of the size of the L2 cache of the respective processor. For example, with respect to some MIPS processors, the number of distinct memory pools is limited to 16 pools. The limited number of pools may be inadequate for a given number of applications and processes that need to be supported, such as those on a typical Integrated Modular Avionics (IMA) system. Additionally, allocating L2 cache pools based on the size of their main memory footprint is seen as an undesirable constraint since it can force allocation of L2 cache pools to partitions that may not have a correspondingly large enough execution time footprint.

The embodiments described herein provide a solution to the potential problem with the L2 cache partitioning described in the '308 patent. For example, some embodiments described herein include L2 memory pools 142 similar to those described in the '308 patent. However, the embodiments described herein further include one or more additional new L1-only memory pool(s) 134 which are not cached by the L2 cache 126. Thus, the L2 cache 126 is bypassed such that a copy of the data in the L1-only pool(s) 134 is not maintained in the L2 cache 126. Hence, the microprocessor 110 of FIG. 1 can be configured to reserve the L2 cache 126 for high priority tasks and assign lower priority tasks to the L1 cache 122 by assigning the lower priority tasks to the L1-only pool(s) 134, for example. The priority of each task can be based on one or more of criticality, throughput, memory needs, or partitioning considerations, for example. Thus, the embodiments herein extend the concept of L2 cache partitioning by assigning a new class of memory pool for the CPU 102, namely one that is covered by the L1 cache 122, but excluded from the partitioned L2 cache. In addition, it is to be understood that the new class of memory pool covered only by the L1 cache 122 can also be implemented in embodiments without partitioning the L2 cache.

This new, potentially large memory pool 134 associated with the L1 cache 122 can be allocated to various tasks or processes (also referred to herein as threads) that have been determined to not need the execution time enhancing properties of access to the CPU's L2 cache 126, thus freeing up L2 memory pools 142 for the threads that will benefit the most. The new L1-only memory pool 134 can also be used for inter-process communications or other shared memory areas. Although some processor types, such as typical PowerPC processors, have sufficient memory pools for their respective implementation and, thus, may not need an L1-only memory pool, it is to be understood that the L1-only pool can be implemented for any processor type which has a mechanism for bypassing the L2 cache.

In this embodiment, the L1-only memory pool 134 is implemented via an L1 attribute (also referred to herein as a bypass state) for entries in the TLB 124 corresponding to the L1-only memory pool 134. In particular, each page in a lookup table of the TLB 124 corresponds to a block of memory (e.g. a 4k block) in the main memory 128. The corresponding page provides an address translation from a virtual address to a physical address, as understood by one of skill in the art. Thus, an L1 attribute is set for each page corresponding to an address within the L1-only memory pool 134 which disables the L2 cache 126 for the corresponding block of memory.

For example, the embodiment of FIG. 1 takes advantage of the capability of some MIPS processors to specify a Fast Packet Cache (FPC) page coherency attribute mode for each block of memory which disables the L2 cache 126 for the corresponding block of memory. The TLB page coherency bits control whether references to the page should be cached and if so, the algorithm selects between several coherency attributes, including FPC. In particular, the FPC coherency (L1 attribute) is applied, in this example, via the modified TLB interrupt handler 140 rather than in the various lookup tables of the TLB 124 by overriding the current caching policy with FPC as applicable. That is, the FPC logic is implemented in the interrupt routine of the modified TLB interrupt handler 140 such that impact on memory management is reduced as compared to setting the coherency attribute directly in the respective pages of the TLB lookup tables. For example, a MIPS processor's architecture is superscalar which enables the execution of two instructions per clock cycle. Additionally, the modified TLB interrupt handler 140 is a high-frequency code. Through selective ordering of instructions/operations of the modified TLB interrupt handler 140, the CPU 102 is configured to take advantage of the superscalar architecture to provide the extra functionality of implementing the FPC logic with little to no impact on the timing of the modified TLB interrupt handler 140 as compared to a conventional TLB interrupt handler.

The modified TLB interrupt handler 140 implements a dual-tier architecture similar to conventional TLB interrupt handlers for a MIPS processor. In particular, the first table is a Page Directory Table (PDT), which is a 4K byte table that decodes the upper bits of a virtual address to determine the start of the second page table. The second table, which is pointed to by the PDT, is the page table (PT) itself. In this implementation, the two tables are each 4K bytes and control the TLB final physical address and attributes of the corresponding pair of 4K byte pages. In a conventional TLB interrupt handler on the MIPS processor, the two tables are referenced through the memory region known to one of skill in the art as KSeg0, which is a linearly mapped memory region (i.e. virtual address=physical address). However, the modified TLB interrupt handler 140 accesses the PT for the L1-only memory pool 134 from a different memory region, such as KSeg3 which is a memory region known to one of skill in the art that uses TLB protocols to resolve the virtual addresses. In addition, in the modified TLB interrupt handler 140, the TLB entry 0 is dedicated to the KSeg3 region in this example such that the TLB entry has the appropriate FPC attribute set so that all corresponding reads utilize only the L1-cache and those reads are mapped linearly. This allows normal page accesses from KSeg0 and L1-only accesses from KSeg3.

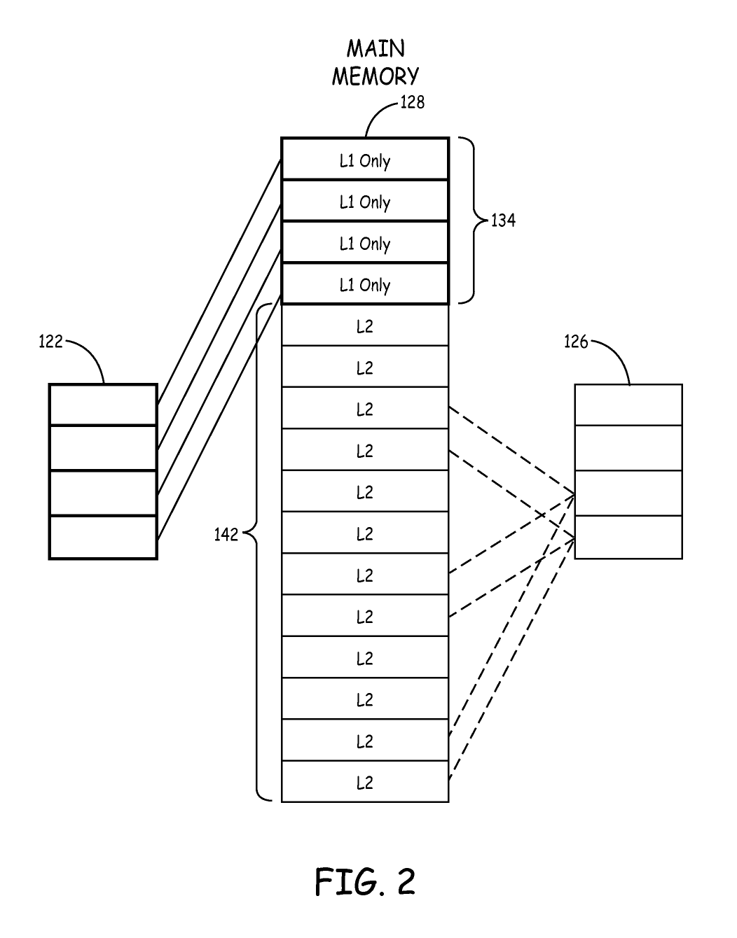

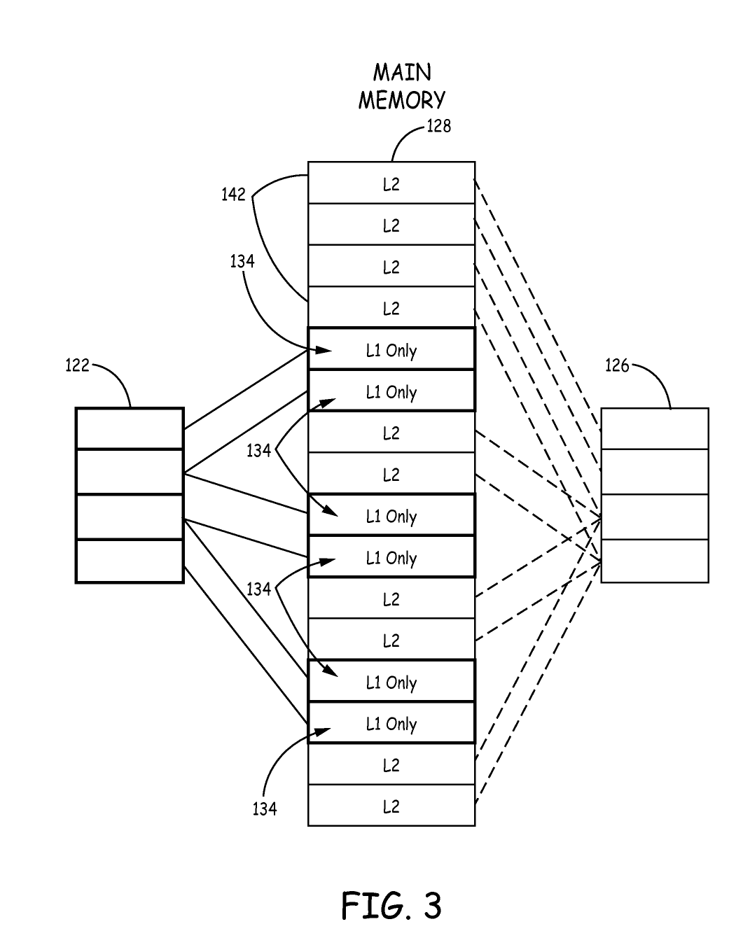

In some embodiments, such as shown in FIG. 2, the L1-only memory pool 134 comprises a single continuous block of memory. The size of the continuous block can vary based on the specific implementation. For example, in one embodiment, the block of memory for the L1-only memory pool 134 is aligned on 64K byte boundaries. In such embodiments, the address range and size of the L1-only memory pool 134 is static. However, in other embodiments, such as shown in FIG. 3, the L1-only memory pool 134 comprises a plurality of separate blocks of memory. In such embodiments, the total size of the L1-only memory pool can be dynamic. For example, in some such embodiments, each separate block of memory in the L1-only memory pool 134 is 128 MB. In addition, the addresses of blocks corresponding to the L1-only memory pool 134 can also be dynamic. Hence, embodiments utilizing separate blocks of memory, such as shown in FIG. 3, enable the L1-only pool 134 to be divided into multiple L1-only pools. Thus, an L1-only pool can be configured for different memory devices, such as, but not limited to Random Access Memory (RAM), such as Synchronous Dynamic RAM and fastRAM (e.g., memory inside a custom bridge application specific integrated circuit (ASIC)), aliased cached areas of the CPU Bus 104, NOR flash Read Only Memory (ROM), BITE memory, etc.

In one embodiment, a 32 bit control word is used, where each bit corresponds to a respective 128 MB region of main memory 128. However, it is to be understood that the control word is not limited to a 32 bit word. For example, in one embodiment, a 64 bit control word or a 16 bit control word can be used. In addition, the size of a region corresponding to each bit in the control word varies based on the size of the control word. For example, a 64 bit control word has a resolution of 64 MB instead of 128 MB. The size of the control word is selected for each implementation to have a fast discriminator to determine if the caching policy needs to be overridden with FPC.

Each bit can be set to indicate whether or not the respective 128 MB region utilizes the L1 cache only and thus, is a member of the L1-only memory pool 134. For example, in some embodiments, a ‘0’ means that the respective region is mapped normally including L2 or L3 caches, as described in the '308 application for example. A ‘1’ indicates that the respective region is mapped only to the L1 cache, as described herein. In addition, a non-cached memory pool can also be included in some embodiments. A non-cached memory pool is a region which is not cached by either the L1 cache 122 or the L2 cache 126. A non-cached pool can be configured using a Memory Management Unit (MMU), for example. An MMU is known to one of skill in the art and not described in more detail herein.

The control word is specified for the specific operating system (OS), such as a real-time operating system (RTOS) like Deos™ by DDC-I, Inc. or other RTOS. In some embodiments, the operating system provides the control word to the modified TLB interrupt handler 140 in the same control structure that contains the address of the PDT. For example, the control structure and the PDT are accessed from a memory pool of the OS through the L2 cache 126. Once the address of the PT is read from the PDT, that address is set to point to a user memory pool. The modified TLB interrupt handler 140 uses the control word to determine if the 128 MB region containing the current PT being accessed is to be accessed through KSeg0 (L2 cache 126) or Kseg3 (L1 cache 122). The PT entries are then examined to determine if the physical address of an entry is within a 128 MB region associated with the L1-only cache pool 134. If the physical address of an entry is associated with the L1-only cache pool 134, the modified TLB interrupt handler 140 replaces the caching policy field of the TLB entry with the L1 attribute discussed above. In this embodiment, each PDT entry controls two 4K pages (Hi and Lo) and, thus, two PT words are read and decoded to fill in a single TLB entry. Thus, a total of 3 caching policy decisions are made, in this embodiment, based on the control word per TLB interrupt.

However, as stated above, the selective ordering of instructions in the modified TLB interrupt handler 140 enables the modified TLB interrupt handler 140 to include the additional functionality of implementing the L1-only cache with little negative impact on the timing as compared to a conventional TLB interrupt handler. For example, in some embodiments, the modified TLB interrupt handler 140 has been ordered such that for an L1-only pool 134 comprising a single continuous block, only 3 additional clocks are needed for a kernel miss and 8 additional clocks for a user miss versus a conventional TLB interrupt handler. Similarly, in other embodiments for an L1-pool 134 comprising a plurality of discontinuous blocks of memory, the modified TLB interrupt handler 140 can be ordered such that 1 less clock for a kernel miss and 5 additional clocks for a user miss are needed versus a conventional TLB interrupt handler. It is to be understood that the number of clocks needed depends on the implementation and are presented by way of example only, not by way of limitation.

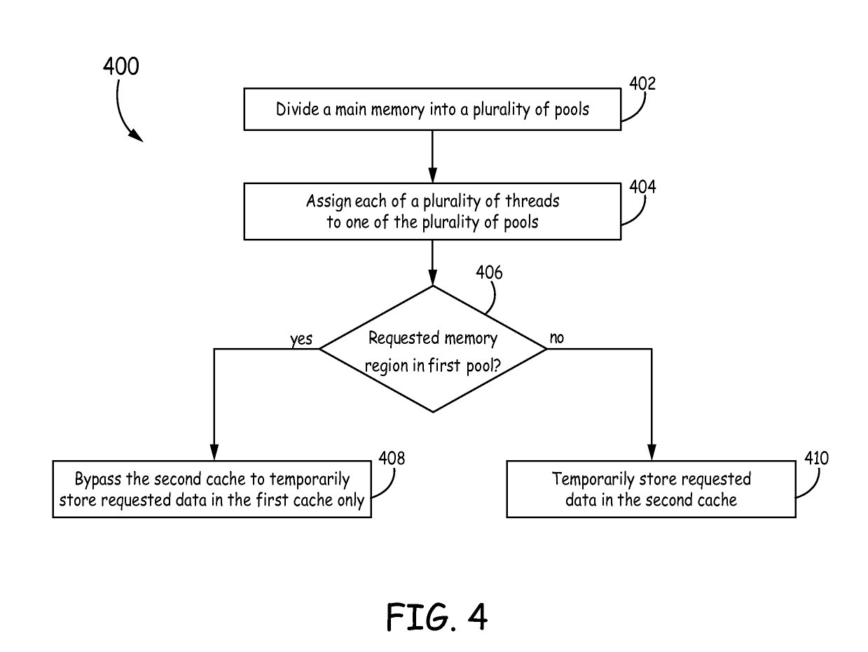

FIG. 4 is a flow chart depicting one embodiment of an exemplary method 400 of enabling a computing system, such as system 100 discussed above. At block 402, a main memory is divided into a plurality of pools, such as described above. Each pool comprises a region of the main memory. In particular, the plurality of pools includes a first pool and one or more second pools. The first pool is only associated with a set of one or more lines in a first cache (L1) such that data in the first pool is only cached in the first cache, as described above with respect to the L1-only pool 134. In some embodiments, the first pool comprises a single continuous region of the main memory. In other embodiments, the first pool comprises a plurality of discontinuous regions of the main memory. Additionally, the one or more second pools are each associated with one or more lines in a second cache (L2 or L3), such as described above and in the '308 application. Data in the second cache is cacheable by the first cache such that data cached by the second cache is not necessarily exclusive of data cached by the first cache.

At block 404, each of a plurality of threads is assigned to one of the plurality of pools. For example, in some embodiments, the respective priority of each thread can be used to determine which threads are assigned to which pools. Additionally, in some such embodiments, higher priority threads are assigned to the one or more second pools which are cached by the second cache and lower priority threads are assigned to the first pool which is only cached by the first cache. Thus, data for lower priority tasks or threads reside briefly in the first cache without evicting less-transient data of higher priority tasks from the second cache.

At block 406, it is determined if the memory region being accessed belongs to the first pool. If the memory region belongs to the first pool, the second cache is bypassed to temporarily store data from the first pool memory region only in the first cache at block 408. For example, as described above a bypass state can be set for a page entry in a TLB where the page entry corresponds to a physical address within the first pool. In some embodiments, the Fast Packet Cache attribute of a MIPS processor is the bypass state. Additionally, in some embodiments, the bypass state is set via the TLB interrupt handler as discussed above. If tasks are uniquely assigned memory from the L1-only pool or a non-cached pool, then the cache will be deterministically partitioned. Any number of cache partitions can be assigned to a given task. The operating system ensures that only memory from the proper memory pool is assigned to each task. If the memory region being accessed does not belong to the first pool, the requested data is temporarily stored in the second cache at block 410.

The method 400 can be implemented via a processing unit, such as CPU 102, which includes or functions with software programs, firmware or other computer readable instructions for carrying out various methods, process tasks, calculations, and control functions, used in bypassing the second cache for specified regions of the main memory, as discussed above.

These instructions are typically stored on any appropriate computer readable medium used for storage of computer readable instructions or data structures. The computer readable medium can be implemented as any available media that can be accessed by a general purpose or special purpose computer or processor, or any programmable logic device. Suitable processor-readable media may include storage or memory media such as magnetic or optical media. For example, storage or memory media may include conventional hard disks, Compact Disk-Read Only Memory (CD-ROM), volatile or non-volatile media such as Random Access Memory (RAM) (including, but not limited to, Synchronous Dynamic Random Access Memory (SDRAM), Double Data Rate (DDR) RAM, RAMBUS Dynamic RAM (RDRAM), Static RAM (SRAM), etc.), Read Only Memory (ROM), Electrically Erasable Programmable ROM (EEPROM), and flash memory, etc. Suitable processor-readable media may also include transmission media such as electrical, electromagnetic, or digital signals, conveyed via a communication medium such as a network and/or a wireless link.

### EXAMPLE EMBODIMENTS

Example 1 includes a method for enabling a computing system, comprising: dividing a main memory into a plurality of pools, the plurality of pools including a first pool and one or more second pools, wherein the first pool is only associated with a set of one or more lines in a first cache such that data in the first pool is only cached in the first cache and wherein the one or more second pools are each associated with one or more lines in a second cache and data in the second cache is cacheable by the first cache; assigning each of a plurality of threads to one of the plurality of pools; determining if a memory region being accessed belongs to the first pool; and if the memory region being accessed belongs to the first pool, bypassing the second cache to temporarily store data from the memory region in the first cache.

Example 2 includes the method of Example 1, wherein assigning each of the plurality of threads to one of the plurality of pools comprises assigning each of the plurality of threads to one of the plurality of pools based on the respective priority level of each thread.

Example 3 includes the method of Example 2, wherein assigning each of the plurality of threads to one of the plurality of pools based on the respective priority level of each thread comprises assigning low priority threads to the first pool.

Example 4 includes the method of any of Examples 1-3, wherein the first pool comprises a single continuous region of the main memory.

Example 5 includes the method of any of Examples 1-4, wherein the first pool comprises a plurality of discontinuous regions of the main memory.

Example 6 includes the method of any of Examples 1-5, wherein bypassing the second cache comprises: setting a bypass state in a page table entry of a translation look-aside buffer (TLB) corresponding to a physical address within the first pool, the bypass state indicating that the second cache is to be bypassed for the corresponding physical address.

Example 7 includes the method of Example 6, wherein setting the bypass state comprises setting the bypass state via a TLB interrupt handler.

Example 8 includes a computing system comprising: at least one processing unit; a main memory divided into a plurality of memory pools, wherein each memory pool comprises a region of the main memory; a first cache; and a second cache, each of the first and second caches configured to cache data from the main memory, wherein data in the second cache is cacheable by the first cache; wherein a first pool of the plurality of memory pools is associated only with the first cache such that the first pool bypasses the second cache and is mapped only to a set of one or more lines in the first cache.

Example 9 includes the computing system of Example 8, wherein each of a plurality of threads executed by the at least one processing unit is assigned to one of the plurality of memory pools based on the respective priority of each thread.

Example 10 includes the computing system of Example 9, wherein low priority threads are assigned to the first pool.

Example 11 includes the computing system of any of Examples 8-10, wherein the first pool comprises a single continuous region of the main memory.

Example 12 includes the computing system of any of Examples 8-11, wherein the first pool comprises a plurality of discontinuous regions of the main memory.

Example 13 includes the computing system of any of Examples 8-12, further comprising: a translation look-aside buffer (TLB) comprising a plurality of page table entries and configured to translate a virtual address into a physical address of the main memory; wherein a bypass state set in a page table entry which corresponds to a physical address within the first pool indicates that the second cache is to be bypassed for the corresponding physical address.

Example 14 includes the computing system of Example 13, wherein the processing unit is configured to execute a TLB interrupt handler modified to set the bypass state.

Example 15 includes a program product comprising a non-transitory processor-readable medium on which program instructions are embodied, wherein the program instructions are configured, when executed by at least one programmable processor, to cause the at least one programmable processor to: divide a main memory into a plurality of pools, the plurality of pools including a first pool and one or more second pools, wherein the first pool is only associated with a set of one or more lines in a first cache such that data in the first pool is only cached in the first cache and wherein the one or more second pools are each associated with one or more lines in a second cache and data in the second cache is cacheable by the first cache; assign each of a plurality of threads to one of the plurality of pools; and for each thread assigned to the first pool, bypass the second cache to temporarily store data from the first pool in the first cache.

Example 16 includes the program product of Example 15, wherein the program instructions are further configured to cause the at least one programmable processor to assign each of the plurality of threads to one of the plurality of pools based on the respective priority level of each thread.

Example 17 includes the program product of Example 16, wherein the program instructions are further configured to cause the at least one programmable processor to assign low priority threads to the first pool.

Example 18 includes the program product of any of Examples 15-16, wherein the program instructions are further configured to cause the at least one programmable processor to divide the main memory into a plurality of pools such that the first pool comprises one of a single continuous region of the main memory or a plurality of discontinuous regions of the main memory.

Example 19 includes the program product of any of Examples 15-17, wherein the program instructions are further configured to cause the at least one programmable processor to bypass the second cache by setting a bypass state in a page table entry of a translation look-aside buffer (TLB) corresponding to a physical address within the first pool, the bypass state indicating that the second cache is to be bypassed for the corresponding physical address.

Example 20 includes the program product of Example 19, wherein the program instructions are further configured to cause the at least one programmable processor to implement a TLB interrupt handler to set the bypass state.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof

What is claimed is:

1. A method for enabling a computing system, comprising:
dividing a main memory into a plurality of pools, the plurality of pools including a first pool and one or more second pools, wherein the first pool is only associated with a set of one or more lines in a first cache such that data in the first pool is only cached in the first cache and wherein the one or more second pools are each associated with one or more lines in a second cache and data in the second cache is cacheable by the first cache;
assigning each of a plurality of threads to one of the plurality of pools;
determining if a memory region being accessed belongs to the first pool; and
if the memory region being accessed belongs to the first pool, bypassing the second cache to temporarily store data from the memory region in the first cache.

2. The method of claim 1, wherein assigning each of the plurality of threads to one of the plurality of pools comprises assigning each of the plurality of threads to one of the plurality of pools based on the respective priority level of each thread.

3. The method of claim 2, wherein assigning each of the plurality of threads to one of the plurality of pools based on the respective priority level of each thread comprises assigning low priority threads to the first pool.

4. The method of claim 1, wherein the first pool comprises a single continuous region of the main memory.

5. The method of claim 1, wherein the first pool comprises a plurality of discontinuous regions of the main memory.

6. The method of claim 1, wherein bypassing the second cache comprises:
setting a bypass state in a page table entry of a translation look-aside buffer (TLB) corresponding to a physical address within the first pool, the bypass state indicating that the second cache is to be bypassed for the corresponding physical address.

7. The method of claim 6, wherein setting the bypass state comprises setting the bypass state via a TLB interrupt handler.

8. A computing system comprising:
at least one processing unit;
a main memory divided into a plurality of memory pools, wherein each memory pool comprises a region of the main memory;
a first cache; and
a second cache, each of the first and second caches configured to cache data from the main memory, wherein data in the second cache is cacheable by the first cache;
wherein a first pool of the plurality of memory pools is associated only with the first cache such that the first pool bypasses the second cache and is mapped only to a set of one or more lines in the first cache.

9. The computing system of claim 8, wherein each of a plurality of threads executed by the at least one processing unit is assigned to one of the plurality of memory pools based on the respective priority of each thread.

10. The computing system of claim 9, wherein low priority threads are assigned to the first pool.

11. The computing system of claim 8, wherein the first pool comprises a single continuous region of the main memory.

12. The computing system of claim 8, wherein the first pool comprises a plurality of discontinuous regions of the main memory.

13. The computing system of claim 8, further comprising:
a translation look-aside buffer (TLB) comprising a plurality of page table entries and configured to translate a virtual address into a physical address of the main memory;
wherein a bypass state set in a page table entry which corresponds to a physical address within the first pool indicates that the second cache is to be bypassed for the corresponding physical address.

14. The computing system of claim 13, wherein the processing unit is configured to execute a TLB interrupt handler modified to set the bypass state.

15. A program product comprising a non-transitory processor-readable medium on which program instructions are embodied, wherein the program instructions are configured, when executed by at least one programmable processor, to cause the at least one programmable processor to:
divide a main memory into a plurality of pools, the plurality of pools including a first pool and one or more second pools, wherein the first pool is only associated with a set of one or more lines in a first cache such that data in the first pool is only cached in the first cache and wherein the one or more second pools are each associated with one or more lines in a second cache and data in the second cache is cacheable by the first cache;
assign each of a plurality of threads to one of the plurality of pools; and
for each thread assigned to the first pool, bypass the second cache to temporarily store data from the first pool in the first cache.

16. The program product of claim 15, wherein the program instructions are further configured to cause the at least one programmable processor to assign each of the plurality of threads to one of the plurality of pools based on the respective priority level of each thread.

17. The program product of claim 16, wherein the program instructions are further configured to cause the at least one programmable processor to assign low priority threads to the first pool.

18. The program product of claim 15, wherein the program instructions are further configured to cause the at least one programmable processor to divide the main memory into a plurality of pools such that the first pool comprises one of a single continuous region of the main memory or a plurality of discontinuous regions of the main memory.

19. The program product of claim 15, wherein the program instructions are further configured to cause the at least one programmable processor to bypass the second cache by setting a bypass state in a page table entry of a translation look-aside buffer (TLB) corresponding to a physical address within the first pool, the bypass state indicating that the second cache is to be bypassed for the corresponding physical address.

20. The program product of claim 19, wherein the program instructions are further configured to cause the at least one programmable processor to implement a TLB interrupt handler to set the bypass state.
